(19) United States
(12) Patent Application Publication
(10) Pub. No.: US 2022/0212090 A1
(43) Pub. Date: Jul. 7, 2022

(54) FANTASY SPORTS USING PLAYING CARDS SCHEMA

(71) Applicant: Fantasy River, Inc,, Frederick, MD (US)

(72) Inventors: Kenneth A. Malnar, Frederick, MD (US); Dustin Bane, Frederick, MD (US)

(21) Appl. No.: 17/567,237

(22) Filed: Jan. 3, 2022

Related U.S. Application Data
(60) Provisional application No. 63/133,584, filed on Jan. 4, 2021.

(51) Int. Cl. A63F 1/04; A63F 13/828; A63F 1/18; A63F 13/30; A63F 13/46

(52) U.S. Cl. CPC A63F 1/04; A63F 13/828; A63F 2001/005; A63F 13/30; A63F 13/46; A63F 1/18

(57) ABSTRACT

Live fantasy sports is played in a card game context wherein each participant's team of sport players is obtained through a poker card game format. The sports players are represented in a deck of playing cards based on a specified sporting event or slate of sporting events that occur between future set start and end dates and times. Poker gameplay determines which cards, and therefore which sports players, are in each participant's team. Scoring is determined based on results from the specified sporting event or events t and each participant's hand of sport players has been determined.

### CROSS REFERENCE TO RELATED APPLICATIONS

This application is a non-provisional application claiming priority from U.S. Provisional Application No. 63/133,584, entitled “Live Fantasy Sports Using Playing Cards Schema”, and filed Jan. 4, 2021, the disclosure in which is incorporated in its entirety herein by this reference.

### TECHNICAL FIELD

The disclosure generally relates to live fantasy sports and, more particularly, to fantasy sports played in a card game context.

### BACKGROUND OF THE DISCLOSURE

Fantasy sports, in which participants have a number of actual professional sports players on their teams and then manage that team and compete against other participants for a defined number of sporting events, has become part of the American sports culture and is enjoyed as a recreational pastime by over fifty million people. Since the first fantasy sports leagues were first conceived in the 1960s, the basic rules of play, which are well known by anyone having familiarity with fantasy sports, have remained essentially the same. There have been only a few significant evolutions in fantasy sports which include: the invention of ‘rotisserie’ leagues in 1980, in which players have pre-assigned purchase values and owners must build a team based on their budget; the emergence of ‘daily’ fantasy sports in 2007, in which the winners of a fantasy sports contest were determined as soon as the associated set of actual sporting events were completed rather than the end of a professional league season; the migration of fantasy sports to the internet and on mobile devices; and the dramatic increase in legal wagering on fantasy sports (online fantasy sports gambling is legal in all but six of the fifty United States and the District of Columbia).

Even with these evolutions, the basics of how fantasy sports is played has not changed. Game participants draft the actual sports players they want on their fantasy team (or daily lineup), and then wait for the actual sporting events to be played. Points are awarded based on the performance of the actual players (e.g., one point for ten yards rushing, four points for a home run, etc.), the points are summed for all players on the participant's team, and the winner of the fantasy contest is the participant with the most points. The winner can be declared as soon as the sporting event(s) is/are over (daily fantasy), or at the end of a season of sporting events (fantasy leagues). There are a couple minor variations that are common in all fantasy football operations, including how players are selected (or ‘drafted’) for a participant's team (e.g., taking turns choosing players from an available pool, or selecting players based on ‘salaries’ with a limited amount of funds that can be spent on the entire team); whether participants can have the same players on their team or not; how fantasy points are calculated; and whether or not there are wagers involved.

However, the general principle of creating a team through some form of a draft of sports players to fill out all of the required sports positions has remained constant. This can be a rather long process and can require significant time put into research and analytical tools.

After sixty years of fantasy sports being played the same way at its core, the need exists for variations and improvements that will generate more participant entertainment in the process of obtaining a fantasy team, which will in turn lead to more interest, activity and recreational enjoyment. This would be especially impactful if the improvement is based upon another game or activity that is also widely known and played, which would make the improved method easy to learn and more fun to play.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Embodiments of the present invention are directed at providing a method and system for competing in a fantasy sport competition, whereas the participant's team of sport players is obtained through a poker card game format. The method includes sports players represented in a deck of playing cards based on a specified slate of sporting events that occur between a set start date and time and set end date and time.

One possible deck of cards for a specific slate may comprise a single card for each sport player. Another possible deck will include 4 cards for each sport player. Other combinations of quantities of sports player cards are also possible for creating a deck.

Participants obtain their teams of sport players based on hands of dealt cards from the deck of sports player cards. One possible option is for all participants to share a single deck of sport playing cards, whereby a card can be held by only a single participant, limiting possible outcomes. Another option is for all participants to receive cards from their own personal deck, allowing for a larger number of participants and potential outcomes for a single hand.

Hands are played based on traditional poker games. One such possibility is Five-Card Draw, where each participant enters an ante (monetary entry fee) and then receives five cards initially. Based on their cards, and using their sports-related knowledge and strategy skills, participants decide whether they would like to play the hand or fold. Participants that choose to play the hand pay a second monetary fee to play and have the option to discard a number of their cards to receive a second set of cards equal to the number they discarded to create their final hand of five cards. This Five-card draw method is just one example of methods for participants to obtain their teams of sports players. Other card games such as Five-Card Stud, Seven-Card Stud and Texas Hold'em are some of the other examples of methods for obtaining a participant's fantasy sport team. This method could be extended to any number of traditional poker games. Further. The ante and play fee combination is just one example of a fee structure, as there are many other options for multiple fixed fees during a hand, with the monetary value varying for different gameplay. A free version with no betting is another option.

Scoring is determined based on results from a sporting event taking place at a future time after gameplay has been completed and each participant's hand of sport players has been determined. The score for each participant's hand is determined based on the sum of each of the participant's player's statistics for the sporting event. For example, in a traditional football scoring example, a participant receives six points for a touchdown scored by a sports player in his/her hand for the sporting event in the slate of games chosen. Similarly, participants may receive one point for each ten rushing yards by a player in their hands. Traditional scoring for each fantasy sport is available with options for custom scoring capabilities. Multiple potential scoring options with bonus points based on typical poker hands, such as a pair (where as a pair may be defined as having two cards with the same player, team or playing position, e.g., running back), or a flush (where a flush may be defined as having 5five cards for the same player, team or playing position), may be available and may accrue bonus points based on a multiplier for the hand type that may be multiplied against the fantasy points achieved by the sports player's statistics for the sporting event in the slate of games chosen. Winners and payouts of each hand will be based on the highest total points achieved by each participant's hand based on the scoring structure set forth in each hand's gameplay rules. It is one option for there to be a single winner that takes the full payout and another option for multiple participants to receive payouts based on their finishing order, whereas the highest finisher receives a higher percentage of the payout.

Embodiments of the invention are also directed at a mobile application and web application connected through a cloud database. Gameplay occurs in real time with participants utilizing a mobile device, laptop, desktop or other CPU connected to an active internet connection. Gameplay to create each participant's hand occurs over this secured connection in real time. Participants are then able to follow scoring of their hands during the sporting events for the specific slate in real time. At a set specific amount of time after the final contest for a specific slate is complete, scoring will be locked, and results and payouts are determined.

A method, a system and a computer program for providing a fantasy sports game for participants are disclosed comprising: choosing a slate of one or more future sports events in which a plurality of sports players are scheduled to play; providing a deck of cards wherein each card represents a respective sports player in said plurality of sports players; playing a poker game in which the participants are dealt cards from said deck to define an initial hand of cards and wherein the participants can exchange cards in their initial hands in accordance with rules of the poker game; establishing a final hand of cards for each participant by terminating the poker game at a time in advance of the playing said slate; and awarding fantasy sports points for the fantasy sports game to each participant based on the performances in said slate of the sports players represented by the cards in that participant's final hand.

### BRIEF DESCRIPTION OF THE DRAWINGS

By way of example, specific embodiments of the disclosed subject matter will now be described, with reference to the accompanying drawings, in which:

FIG. 1 is a high level block diagram illustrating the technology infrastructure of a preferred embodiment;

FIG. 2 is a flow chart illustrating an example of basic game play using Five-card draw in the embodiment of FIG. 1;

FIG. 3 is an illustration of an example of the sport and card game type selection screen on a mobile phone in the embodiment of FIG. 1;

FIG. 4 is an illustration of an example of the contest selection screen on a mobile phone in the embodiment of FIG. 1;

FIG. 5 is an illustration of an example of the sports player card management screen on a mobile phone in the embodiment of FIG. 1;

FIG. 6 is an illustration of an example of the results of card play for Five-card draw on a mobile phone in the embodiment of FIG. 1;

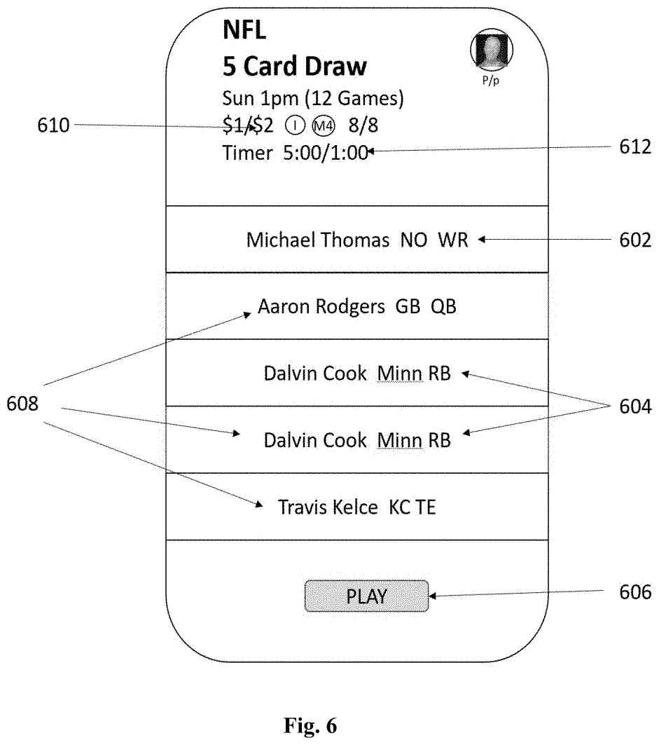

FIG. 7 is an illustration of an example of a sports player card on a mobile phone in the embodiment of FIG. 1; and

FIG. 8 is an illustration of an example of final results for a contest using Five-card draw appearing on a mobile phone in the example of FIG. 1.

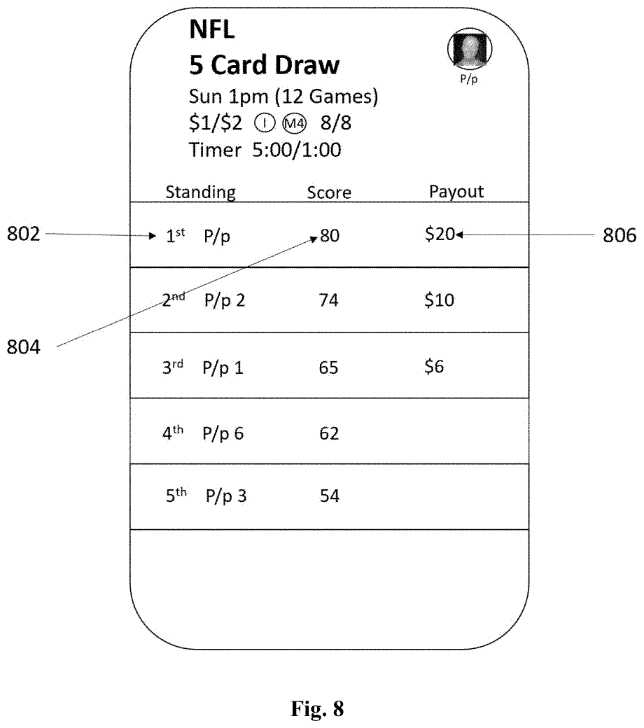

### DETAILED DESCRIPTION

The disclosed embodiments will now be described more fully hereinafter with reference to the accompanying drawings, in which exemplary embodiments are illustrated. It will be readily understood that the components, steps and formats of the embodiments as generally described herein and illustrated in the appended figures could be arranged and designed in a wide variety of different modes. Thus, the following more detailed description of various embodiments, as represented in the figures, is not intended to limit the scope of the present disclosure, but is merely representative of various embodiments.

The disclosed subject matter may be embodied in other specific methods and formats without departing from its spirit or essential characteristics. The described embodiments are to be considered in all respects only as illustrative and not restrictive; that is, the scope of the invention is indicated by the appended claims rather than by this detailed description. All changes and variations which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

The disclosed embodiments are directed at providing a new method and system for competing in a daily fantasy sport competition providing increased gameplay enjoyment and satisfaction, wherein each participant's team of sport players is obtained through a poker card game (or similar game of chance) format. This format may also be used for creating season-long fantasy sports teams.

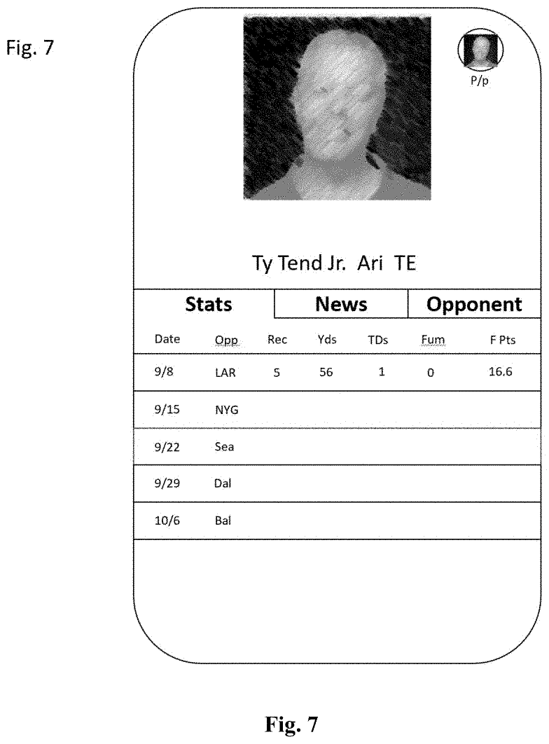

One method includes a deck of playing cards comprised of indicia referencing and pertaining to sports players based on a specified slate of sporting events. In the specific embodiment described below the cards are presented and displayed as electronic images on a participant's smart phone; however, other devices such as tablet, laptops, PCs, etc. may be employed. The playing cards may appear similar to the card shown in FIG. 7 but may be arranged in other presentations or configurations to provide information and data about a sports player. Such information may include information directly displayed on the card or as links to resources providing digitally or electronically based information about the sports players.

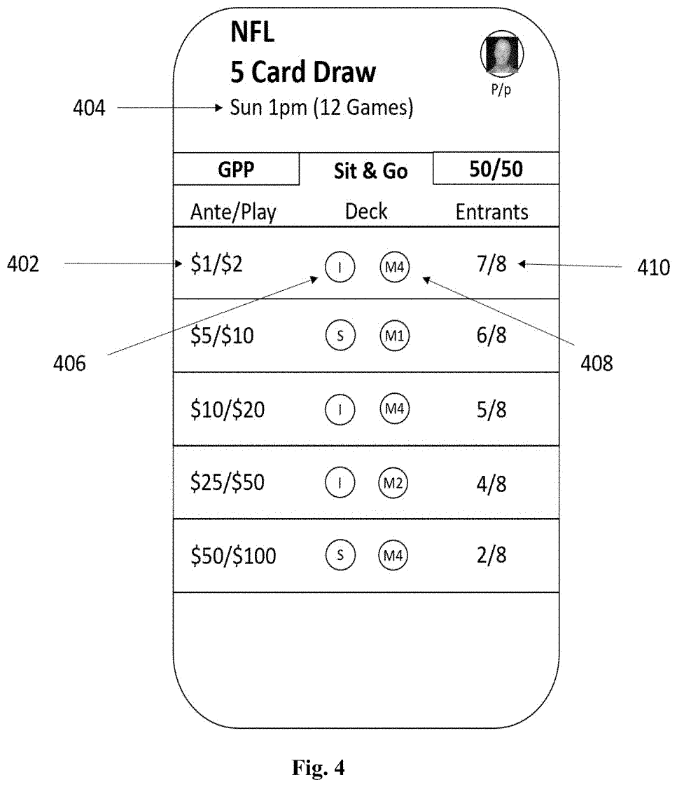

The deck may be comprised of a single card per player in a slate of sporting events or it may comprise multiple cards (two, three, four or more) for each player in the slate of sporting events, allowing for more than one participant to be dealt a certain sports player or even for a single participant to be dealt a pair or more of a certain sports player. This selection is seen at 408 in FIG. 4, with ‘M4’ indicating that there are four cards in the deck for each sports player.

Participants in the contest may be dealt cards from their own individual decks, allowing all possible combinations of cards to be available for all participants. This preference is seen at 406 in FIG. 4 as an selection. Alternatively, each participant in the contest may be dealt cards from a shared deck of cards, thereby limiting possible cards that a participant may receive based on other participants' cards. This preference is seen in FIG. 4 as an ‘S’ selection just below 406.

The slate is defined as a set of sporting events that occur between a set start date and time and a set end date and time. For instance, the slate of games 404 referenced in FIG. 4 is twelve NFL games starting at 1 pm on Sunday. This reference may alternatively be for any sport or any time duration; for example, there may be a slate of just one sporting event for Monday Night Football, or a slate of six baseball games starting between Tuesday at 6 pm and Thursday at 6 pm. It will be appreciated that the slate of sporting events defines the available sports players in the deck.

Various poker game formats may be used, such as Five-Card Draw, Seven Card Stud, Texas Hold'em, etc., to determine the players on each participant's fantasy team. For purposes of this description, Five-Card Draw is used in the examples of gameplay, but any set of poker game rules or any card game may be used with the previously described formations of decks to determine each participant's fantasy teams. Given that the results are based on slates of sporting events played at a future time, time limits for gameplay are implemented to ensure gameplay is completed prior to the commencement of sporting events in the chosen slate.

The actual scoring of the contest is based on traditional fantasy sports scoring systems, which are established in fantasy sports culture and well known, and on actual statistics accrued by the sports players in each participant's hand. For example, a football player may be awarded six points for a touchdown (TD), one point per ten yards rushing or receiving and minus one point for a fumble. Custom scoring is also an option for custom contests created by participants.

Depending on the type of contest, deck and poker style, multipliers can be used as bonus points to the statistics for hand results such as pairs, three of a kinds, flushes and other common poker hands. Options for wild cards and other bonus systems are also possible, but the primary scoring source is based on the actual statistics of the sports players in the sporting contests for the slate chosen.

In these formats the results and payouts are based on the highest scoring hands determined by the statistics resulting from the performance in the slate of sporting events of the sports players in each participant's hand, where the highest number of total points equates to the highest placement among the competing fantasy participants.

Another possible option for scoring is based on predicting fantasy points of the players acquired by a participant during the poker contest gameplay. In this format, each sports player's points are still determined based on his/her statistics in the sporting events of the slate chosen. The participants score and the results of the contest are based on the summation of the delta, or difference, between the participants' predictions of the fantasy scores of the cards in their hands and actual statistical results, where the smallest delta equates to the highest placement. For example, if a participant has sports player A in his hand and predicts the sports player to achieve fifteen fantasy points, and sports player A actually achieves twenty fantasy points, the participant may add five points to his/her total for that hand. Similarly, if the sports player A actually achieved ten fantasy points, the participant would also receive five points for that player equal to the absolute value of the difference between the prediction and true result. In this scenario the higher the points a participant receives, the worse the result in the competition.

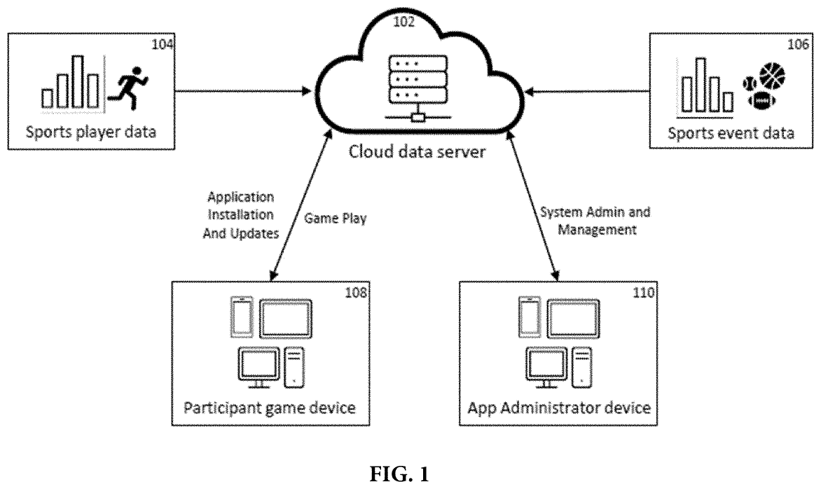

Embodiments disclosed herein are also directed to a mobile application and web application connected through a cloud database. As shown in FIG. 1, a central cloud data server 102 may host the application under the direction of a system app administrator unit 110 which includes a processor containing a computer readable storage medium having program instructions embodied therewith, the program instructions being executable by the system processor to effect the various operations described herein. Sports player data 104 and sporting event data 106 will continually be updated to the cloud data server across a live internet connection. Participants will access the application via a mobile application or website on a mobile device 108, such as a smart phone or tablet, or a desktop device, such as a laptop or PC. Gameplay occurs in real time with participants utilizing their mobile device, laptop, desktop or other PC connected to an active internet connection. Gameplay to create each participant's hand occurs over this secured connection in real time. Participants will then be able to follow scoring of their hands during the sporting events for the specific slate in real time. At a set specific amount of time after the final contest for a specific slate is complete, scoring will be locked, and results and payouts will be determined.

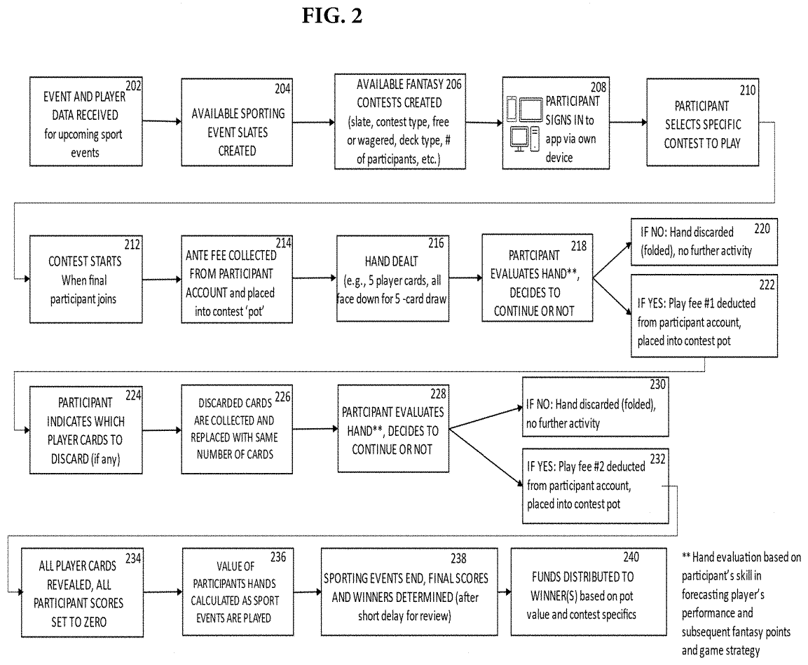

Referring to FIG. 2, a flow chart is provided illustrating an example of a contest using the disclosed method and system. The method may be performed via a web application or mobile app. For this example, Five-Card Draw is used but, again, any card game may be used in this method.

The application receives event and player data for upcoming sporting events at 202 and subsequently creates the slates for that sporting event at 204. For example, matchup and depth chart information for Week 16 NFL games are received, and Sunday at 1 pm and Sunday at 4 pm slates are created. Based on the slates, multiple fantasy contests will be created at 206. These contests may be free to play or include wager, and they may be played by any number of participants and use any deck type.

A participant signs into the application via a mobile or desktop device connected to a live internet connection at 208, and the participant then selects a specific contest to join at 210. An entry fee/ante/wager is collected for all paid contests at 214. The participant may then receive his hand of five cards at 216 from the deck for the specific slate of the current contest. The participant evaluates his hand and decides whether to continue or fold at 218. If the participant continues, he will then decide which cards to discard and which to keep at 224, and will then receive a number of new cards from the deck equivalent to the number of cards discarded. For example, if two cards are discarded by a participant, that participant will no longer have those cards, but will receive two more new cards from the deck. At this point the participant has the option to evaluate his hand again and enter a final entry fee at 232 or fold with no further activity at 230. Participants paying the final entry fee are entered into the contest.

When the sporting events for the contest slate start, participants will receive points for the statistics accrued by the sports players in their hands at 236. Once all sporting events for that slate are complete, the final scores for the hands of all participants are tallied and the winners are determined 238. If it is a wagered/fee tournament, based on the structure and rules of that specific tournament and the number of participants set to be paid out, the payouts will be allocated accordingly 240.

FIG. 2 illustrates just one example of the system and method disclosed herein, it being understood that many variations thereof fall within the scope of the invention.

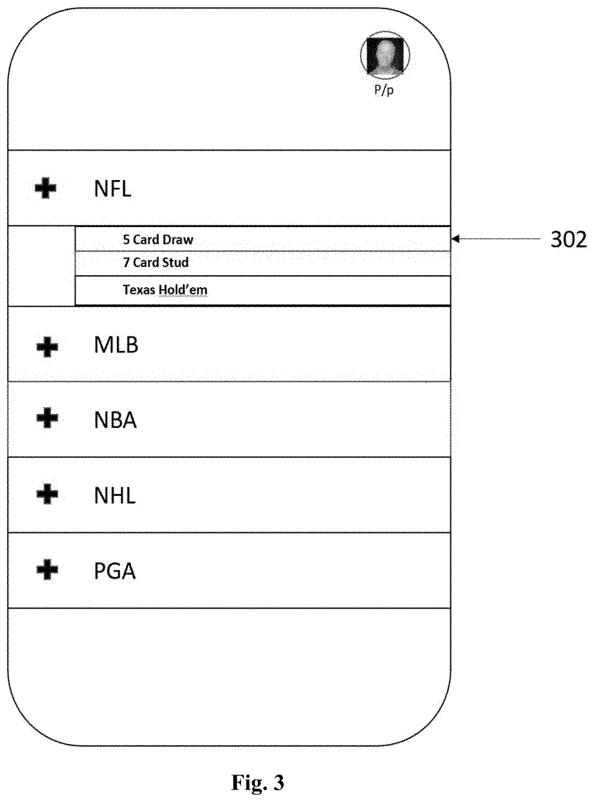

Referring to all of the figures in general, a participant typically logs on to the network illustrated in FIG. 1 via the participant's mobile device 108, and chooses a sport and poker style. Assuming the participant chooses NFL games and Five-Card Draw as shown at 302 in FIG. 3, then, as shown at 402 in FIG. 4, the participant chooses a specific contest based on an ante amount, slate of games 404, type of deck 406, 408 (where indicates in individual deck and ‘M4’ indicates a multi-player deck with each sports player in the deck four times), and the number of participants 410. The screen tabs in FIG. 4 represent formats of game play where GPP refers to guaranteed prize pool, Sit & Go refers to small quantity of participants and fast paced gameplay, and 50/50 refers to game formats in which half the participants win. There are many more game formats that exist, all of which are standard in daily fantasy sports game play and widely known.

In this example the participant chooses an ante structure of $1/$2 402, meaning the ante is $1 to start the contest and then it is $2 to continue to play if the participant likes the hand. This is one format of wagering, but any number of wagering formats could be used including free formats and standard entry fee formats.

In this example the participant chooses the Sunday at 1 pm slate of 12 games 404, but as described previously, a slate could comprise of any number of games across any time period occurring in the future.

In this example the participant also chooses a contest that uses an individual deck 406 designated by I in to circle and meaning that each participant in the contest will be dealt from their own personal deck. Another option would be a contest using a single deck, where all participants are dealt cards from the same deck.

Also in this example the participant chooses a multiplayer 4 deck designated by M4 at 408, meaning that each actual sports player in the current slate of games will be represented by four cards in order to allow for combinations, such as pairs, where a participant gets two of the same player, or three of a kind, or any other multiples of players. These hand types allow for different multipliers to be attributed to cards. For example, if a participant receives two Alvin Kamara cards and Kamara ends up scoring twenty fantasy points in the sporting event for that slate, those twenty points may be multiplied by 1.25, or any other multiplier deemed fit for the particular contest, so that each Alvin Kamara card is worth twenty-five points as opposed to the standard twenty points. Any number of hand combinations such as pairs, three of a kinds, flushes or any other combination of cards may be used to award multipliers or bonus points to the hand, and the multiplier may be attributed to only the cards involved in the combination or the whole hand in its entirety. Other options for one, two, three, or any other quantity of each sports player in a deck are also possible.

The participant in this example chooses a contest with eight entrants at 410. This is the total number of participants in this contest. This number may be as small as two entrants or as large as an unlimited field that could literally allow hundreds of thousands of entrants for one contest. For larger contests, the Individual deck style is required in order to have enough cards to complete gameplay.

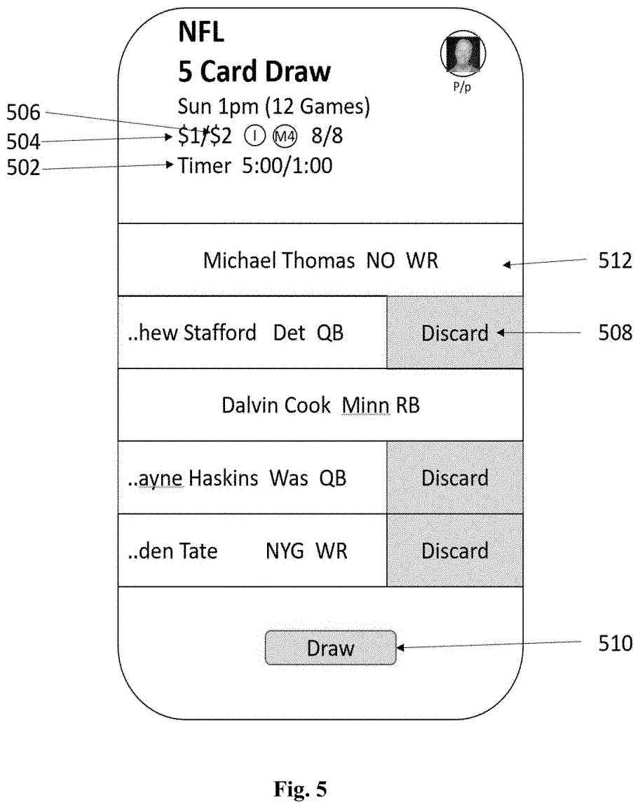

Once these selections have been made and the total number of entrants for that contest has been reached, gameplay commences and participants are charged an ante at 504 (FIG. 5) and dealt their initial hands. For this example, the participant receives Michael Thomas, Matthew Stafford, Dalvin Cook, Dwayne Haskins, and Golden Tate at 512, FIG. 5.

The participant has a predetermined amount of time at 502 to determine if he/she would like to continue to play the hand and pay a fee, at 506, to continue. Any number of specific time limits and rules for application are possible, but in this example “5:00/1:00” means that each participant has five minutes to determine which cards to discard and then one minute to decide whether or not he/she wants to continue play. All participants have this same amount of time determined by the contest type chosen. It is to be understood that this is just one format based on the Five-Card Draw example, and many other formats for timing, antes and fees could be used for different styles of gameplay and card games.

Assume that the participant has decided to continue, he pays the fee and then determines which cards he would like to keep and which cards he would like to discard. The participant also has the option of folding and not paying the added fee if he did not like his hand. In this hand the participant chooses to discard Matthew Stafford 508, Dwayne Haskins, and Golden Tate.

To finalize their selections, the participants click on the “Draw” button 510. Once the time limit has been reached, or all participants have clicked the “Draw” button, the participants will receive their draw cards to replace their discarded cards, creating their final hands that will be used to calculate the results of the contest based on the slate of future sporting events. The example participant in this contest was dealt Aaron Rodgers, Dalvin Cook, and Travis Kelce as their “Draw” cards at 608. Being that this was a Multiplayer 4 Deck it was possible for a participant to get two cards for a single sports player. In this case the participant has a pair of Dalvin Cook's at 604. For this scenario assume that a pair receives a multiplier of 1.25 for each card in the combination. This multiplier is attributed to the fantasy points Dalvin Cook receives for the statistics he achieves in the sporting event for the slate of games for this contest. Importantly, this is just one possible scoring option for specific combinations in just one type of card game being used for this example. In other words, the multiplier could be worth more, less or nothing at all based on the format and rules chosen.

At this point the participants again may have a time limit at 612 for making a decision whether to pay a final fee at 610 or fold their hands, or it may be set to time out at the start time of the first contest in the slate. These are just two possible options; the hand may also be set and not have a 3^{rd} fee option, or there may be many other options for finalizing the gameplay.

In this example the participant has one minute and decides to pay the extra $2 fee to play; he makes that decision by clicking the “Play” button 606.

The hands for this example contest have now been set and the results of the future sporting contests for the slate chosen will determine the outcomes and the payouts. As the sporting events are played and statistics are recorded, participants will be able to follow along to see how their team, as defined by their cards, is doing and see where they rank and what their payout might be.

For this example, assume a traditional point per reception (PPR) scoring format with an added bonus multiplier of 1.25 for any pairs, and the following hypothetical results for the participant's players:
a. Michael Thomas: 5 receptions, 50 receiving yards. One point for each reception gives him five points, and one point for each ten receiving yards gives him another five, totaling ten fantasy points.
b. Aaron Rodgers: 325 passing yards, two TDs. One point for each twenty-five yards passing gives him thirteen points and four points for each Passing TD gives him eight more, totaling twenty-one fantasy points.
c. Dalvin Cook: 100 rushing yards, one TD. One point for each ten yards rushing gives him ten points, and six points for each rushing TD gives him six more, totaling sixteen points. Since the participant has a pair of Dalvin Cooks, multiply his total points by 1.25, giving him a total of twenty points for each Dalvin Cook. As described above for the first Dalvin Cook, Cook's stats plus the pair multiplier result in another twenty fantasy points.
d. Travis Kelce: Five receptions, forty receiving yards. One point for each reception gives him five points and one point for each ten receiving yards gives him another four points, totaling nine fantasy points.

Added together the participant's total fantasy score equals eighty, at 804. For this contest assume that eighty is the highest score and therefore the participant will be ranked first for the contest 802. Based on the amount of money in the hand and the payout rules for the contest, first place receives a payout of $20 at 806.

The above is just one example of Five-Card Draw with standard PPR scoring for fantasy football with a pair multiplier. Any other card game and scoring options could be used, with the main format being the use of a card game to create daily fantasy teams for future sporting contests.

Another possible format covered by the invention is the use of a growing jackpot or lottery format for the perfect hand, where a certain fee is entered for each entry into a jackpot that continues to grow as long as it takes until someone hits the perfect hand, for which that participant will receive the jackpot payout and the rolling jackpot will start over. This could be provided as an add on fee choice to hands in other contests or as a separate entry altogether, with the main idea being a growing pot that gets awarded to a perfect hand, where the perfect hand is defined as the set of fantasy cards for a specific sport and slate that combine to make the highest possible fantasy score for that slate. This is one of any number of options for defining the win to a jackpot. Another option would be for jackpot or bonus payouts for specific types of hands that have extremely low odds of occurring, such as four of a kinds when using a multiplayer 4 deck. Again, there are many potential options for jackpot or lottery type payouts. Other embodiments for playing fantasy sports using a card-game schema include, but are not limited to, the following:
Multi-sport games, in which hands are dealt from a deck based a slate of sporting events that include events from different sports being played during the slate time frame, applying standard or customized fantasy scoring to each sports player's performance.
‘Ladder’ play, similar to ladders in other sports such as tennis, in which participants join a ladder, or a specific number of participants, and compete against each other via head-to-head ‘challenges’ with the winner of the challenge taking over the loser's spot on the ladder.
Embodiments involving gameplay in which all cards are dealt except the last, which is dealt and/or revealed after the actual sporting event is completed, at which time winners are determined, further increasing the recreational enjoyment of fantasy sports.
Embodiments of fantasy sports using a card-game schema using other fantasy sports methods that are common and widely known, including private contests, season-long leagues (either private or public), head-to-head competition, tournaments, custom scoring and leagues, proposition bet based game play, and all other common and widely known fantasy sports and card game methods and game play.

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

The disclosed embodiments include an app, method, system, device, and/or a computer program at any possible technical detail level of integration. The computer program may include a computer readable storage medium (or media) having computer readable program instructions thereon for causing one or more processors to carry out aspects of the present disclosure. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Aspects of the present disclosure are presented with reference to flowcharts and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the accompanying drawings illustrate the architecture, functionality, and operation of possible implementations of systems, methods, and computer program products according to various embodiments of the present techniques. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions

What is claimed is:

1. A method for providing a fantasy sports game for participants comprising:
choosing a slate of one or more future sports events in which a plurality of sports players are scheduled to play;
providing a deck of cards wherein each card represents a respective sports player in said plurality of sports players;
playing a poker game in which the participants are dealt cards from said deck to define an initial hand of cards and wherein the participants can exchange cards in their initial hands in accordance with rules of the poker game;
establishing a final hand of cards for each participant by terminating the poker game at a time in advance of the playing said slate; and
awarding fantasy sports points for the fantasy sports game to each participant based on the performances in said slate of the sports players represented by the cards in that participant's final hand.

2. The method of claim 1, wherein each sports player may be represented in the deck a plurality of times to enable participants to have a plurality of cards representing a given sports player in their initial and final hands.

3. The method of claim 1, wherein all participants are dealt said cards from the same deck to limit the possible cards each participant's hand by the cards in other participants' hands.

4. The method of claim 1, wherein each participant is dealt said cards from that participant's own individual deck that is not shared by any competing participant, thereby not limiting the cards in that participant's hand by cards in competing participants' hands.

5. The method of claim 1 wherein said slate includes sports of different types of sports events.

6. The method of claim 1 wherein the points awarded in the fantasy sports game are modified based on poker scoring rules for the cards in the final hands of the participants.

7. The method of claim 1 wherein the results from each slate are cumulated in a series of sports events such as a season long league to determine the final results of the fantasy sports game.

8. The method of claim 1, wherein each participant is required to predict the number of fantasy sports points each card in that participant's final hand will score in the slate sporting events, and wherein that participants fantasy sports points are modified based on the difference between the participant's predictions and the participant's actual fantasy sports points.

9. The method of claim 1 wherein the cards in the deck are divided before being dealt into different tiers of sports players based on the abilities of the sports players in order to deal each participant equivalent players from each tier.

10. The method of claim 9 wherein the poker game is played on a mobile application over a live data connection.

11. A system comprising a system processor and multiple participant processors in interactive communication with the system processor for providing a fantasy sports game for participants, wherein the system processor is configured to:
choose a slate of one or more future sports events in which a plurality of sports players are scheduled to play;
provide a deck of cards wherein each card represents a respective sports player in said plurality of sports players;
enable participants to play a poker game in which the participants are dealt cards from said deck to define an initial hand of cards and wherein the participants can exchange cards in their initial hands in accordance with rules of the poker game;
establish a final hand of cards for each participant by terminating the poker game at a time in advance of the playing said slate; and
award fantasy sports points for the fantasy sports game to each participant based on the performances in said slate of the sports players represented by the cards in that participant's final hand.

12. The system of claim 11, wherein each sports player may be represented in the deck a plurality of times to enable participants to have a plurality of cards representing a given sports player in their initial and final hands.

13. The system of claim 11, wherein all participants are dealt said cards from the same deck to limit the possible cards each participant's hand by the cards in other participants' hands.

14. The system of claim 11, wherein each participant is dealt said cards from that participant's own individual deck that is not shared by any competing participant, thereby not limiting the cards in that participant's hand by cards in competing participants' hands.

15. The system of claim 11, wherein the points awarded in the fantasy sports game are modified based on poker scoring rules for the cards in the final hands of the participants.

16. The system of claim 11, wherein the cards in the deck are divided before being dealt into different tiers of sports players based on the abilities of the sports players in order to deal each participant equivalent players from each tier.

17. A computer program product for use in a system comprising a system processor and multiple participant processors in interactive communication with the system processor for providing a fantasy sports game for participants, the computer program product comprising a computer readable storage medium having program instructions embodied therewith, the program instructions being executable by the system processor to:
choose a slate of one or more future sports events in which a plurality of sports players are scheduled to play;
provide a deck of cards wherein each card represents a respective sports player in said plurality of sports players;
enable participants to play a poker game in which the participants are dealt cards from said deck to define an initial hand of cards and wherein the participants can exchange cards in their initial hands in accordance with rules of the poker game;
establish a final hand of cards for each participant by terminating the poker game at a time in advance of the playing said slate; and
award fantasy sports points for the fantasy sports game to each participant based on the performances in said slate of the sports players represented by the cards in that participant's final hand.

18. The computer program product of claim 17, wherein each sports player may be represented in the deck a plurality of times to enable participants to have a plurality of cards representing a given sports player in their initial and final hands.

19. The computer program product of claim 17, wherein all participants are dealt said cards from the same deck to limit the possible cards each participant's hand by the cards in other participants' hands.

20. The computer program product of claim 17, wherein each participant is dealt said cards from that participant's own individual deck that is not shared by any competing participant, thereby not limiting the cards in that participant's hand by cards in competing participants' hands.
